(19) United States
(12) Patent Application Publication
(10) Pub. No.: US 2012/0272484 A1
(43) Pub. Date: Nov. 1, 2012

(54) MULTIPOSITION VISOR ADAPTOR SYSTEM

(75) Inventor: Harold Willborn, Surrey (CA)

(73) Assignee: WILLBORN INVENTSTMENTS INCORPORATED, SURREY (CA)

(21) Appl. No.: 13/498,240

(22) PCT Filed: Sep. 29, 2010
(86) PCT No.: PCT/CA10/01517

§ 371 Date: May 14, 2012

Related U.S. Application Data
(60) Provisional application No. 61/248,011, filed on Oct. 2, 2009.

(51) Int. Cl. A44B 99/00; F16B 2/20

(52) U.S. Cl. 24/3.11; 24/3.12

(57) ABSTRACT

This invention relates to a system for connecting a visor to a headset headband, the headband having a headband spring that supports a headpad and a stirrup. The system includes a connector attachable to the headband spring at a user-selected location between the headpad and the stirrup. The connector has a stem. The system also includes an adaptor adjacent the connector and having a first end and a second end. The first end of the adaptor has a slot complementary with the stem for receiving and retaining the stem, such that the adaptor can translate with respect to the connector under user-urging. The second end of the adaptor has a hinge assembly. The system further includes an arm adjacent the adaptor and having a first end and a second end. The first end of the arm has an aperture complementary with the hinge assembly for reception into the hinge assembly, such that the arm can pivot about the second end of the adaptor. The second end of the arm has a securement for securing the visor.

### FIELD

This invention relates to the field of sunshield or protective visors, and more specifically to a visor adaptor system that can be secured to the headband of communication or hearing protection headsets. The visor may be adjusted vertically or horizontally to provide optimally positioned shielding from unwanted glare, or as a means of transparent vision protection.

### BACKGROUND

The two pieces of equipment a pilot commonly uses while flying are: sunglasses and a communication headset. This combination can be uncomfortable to wear, can cause interference with headset function, and can be both inconvenient and sometimes dangerous to use. For example, both items are worn on the head, face and ears, which are sensitive parts of the body. Wearing a headset in conjunction with sunglasses creates discomfort on the ears, as the headset pushes the arms of the glasses onto the ears and head; and onto the bridge of the nose, where the sunglasses rest for long periods of time.

Also, while wearing sunglasses, the arms of the sunglasses break the seal of the headset cushions around the pilot's ear. Engine noise is allowed to leak through, reducing the effective noise reduction of the headset. This problem exists whether the headsets are passive or have noise canceling capabilities. Not only can increased noise be a hardship on the pilot, but it also can interfere with the ability to hear critical communications.

As well, when a pilot is flying an aircraft, the brightness of the sun varies due to the changing position and orientation of the aircraft. It may be overcast at the start of the flight, but once up at altitude the pilot may be exposed to bright sunshine. When the brightness changes, the pilot must don, adjust, or remove the sunglasses, which at worst may involve removing the entire headset. Finally, the headset and sunglasses constitute two more pieces of equipment the pilot must keep track of and keep safe from damage or loss.

One early solution was to clip a pair of armless sunglasses to a rod hanging from and attached to the headset headpad. Unfortunately, this apparatus did not secure the glasses very reliably given the high vector forces on a pilot, and considering the consequences to flight safety when a pilot is inadvertently blinded by sunlight passing around the edges of poorly aligned sunglasses. A better and safer solution is needed.

The art teaches various partial solutions to the above issues, namely flip up visors attached by various means to the outside of earmuffs, or by a locking bolt onto headset stirrups. Unfortunately, all known visor solutions have limited adjustability, adjust only around a single axis, or are not attached to the headset securely enough to preclude dangerous visor misalignment, as discussed above.

Wearing a sunshield visor is more comfortable on long flights because it does not have to contact the face. Also it preserves the seal of hearing protectors, and provides a sunshield of much larger surface area than sunglasses. The problem is how to securely attach a visor to existing aviation headsets while permitting the flexible re-positioning necessary to block sunlight from any direction as needed while a flight progresses through areas of variable illumination.

### SUMMARY

The Multiposition Visor Adaptor System (MVAS) addresses the above deficiencies: increasing user comfort, maintaining headset integrity, increasing sunshield capability, providing operator convenience, permitting increased and flexible visor positioning, and including a secure attachment to the headset.

During its normal use, no part of the visor touches the pilot's face, ears or head. The visor and MVAS are sufficiently lightweight to avert additionally fatiguing the pilot. The seals of the headset cushion are not broken as the visor is mounted to the headset itself, therefore maintaining communications and acoustic integrity. When the angle or brightness that the pilot is exposed to changes, the visor is simply lowered or raised, or extended or retracted, or even removed completely, as required. When the visor is securely mounted to the headset, they form an integrated unit, where there is only one piece of equipment to keep track of and keep safe.

In accordance with one aspect of the present invention, there is provided a system for connecting a visor to a headset headband, the headband having a headband spring that supports a headpad and a stirrup, comprising: a connector attachable to the headband spring at a user-selected location between the headpad and the stirrup, wherein the connector has a stem; an adaptor adjacent the connector and having a first end and a second end, wherein: the first end of the adaptor has a slot complementary with the stem for receiving and retaining the stem, wherein the adaptor is operable to translate with respect to the connector under user-urging, and the second end of the adaptor has a hinge assembly; and an arm adjacent the adaptor and having a first end and a second end, wherein: the first end of the arm has an aperture complementary with the hinge assembly for reception into the hinge assembly, wherein the arm is operable to pivot about the second end of the adaptor, and the second end of the arm has a securement for securing the visor.

The connector might include an elongated bolt slide for slidable attachment to the headband or might be a universal headband connector.

The stem might have a plurality of ratchet teeth and the adaptor might have an index spring configured for operative engagement with the plurality of ratchet teeth on the stem so as to urge the stem to occupy only discrete predetermined positions within the slot. In this regard, the stem might include a plurality of index indicia, each of the plurality of index indicia corresponding to a respective one of the plurality of ratchet teeth and the adaptor might include an index window configured to display a respective one of the plurality of index indicia as a function of a relative position of the stem within the slot.

The hinge assembly might include a hinge tensioner, and might further include a hinge post and a hinge bushing that cooperate with the hinge tensioner to resist a change in tension when the hinge assembly pivots, by isolating the hinge tensioner from pivot forces of the hinge assembly.

The hinge assembly might further include a pair of washers between the hinge post and the hinge bushing to entrap the arm, to further isolate the hinge tensioner from pivot forces. In this regard, the hinge bushing might circumscribe the hinge post and the hinge post might have a perimeter shaped to resist rotation of the hinge bushing; and furthermore, the hinge tensioner might abut the hinge bushing and thread into the hinge post through the hinge bushing to urge the hinge bushing toward the hinge post.

The securement might be shaped to yoke the visor.

In accordance with another aspect of the present invention, there is provided a system for connecting a visor to a headset headband, comprising: a connector attachable to the headband; an adaptor adjacent the connector and having a first end and a second end; an arm adjacent the adaptor and having a first end and a second end, the second end of the arm having a securement for securing the visor; a first translational link for linking the connector and the headband and permitting relative adjustment there between; a second translational link for linking the connector and the first end of the adaptor and permitting relative adjustment there between; and a rotational link for linking the second end of the adaptor and the first end of the arm and permitting relative adjustment there between.

In this regard, it might be arranged that at least one of: the connector cooperates with the headband to provide the first translational link; the connector and the adaptor cooperate to provide the second translational link; and the adaptor and the arm cooperate to provide the rotational link. It might also be arranged that at least one link is operable to unlink, for example the first end of the adaptor being operable to unlink from the connector.

It might also be arranged that at least one link is indexed. For example, the at least one link might include an index window for indicating relative adjustment.

More specifically, the connector might include a stem and the first end of the adaptor might include a slot, wherein the stem and slot cooperate to provide the second translational link.

Similarly, the second end of the adaptor might include a hinge assembly and the first end of the arm might include an aperture, wherein the hinge assembly and the aperture cooperate to provide the rotational link.

### FIGURES

The invention will be more fully illustrated by the following detailed description of non-limiting specific embodiments in conjunction with the accompanying drawing figures. In the figures, similar elements and/or features may have the same reference label.

Most elements of this invention are symmetrical; therefore, inside-outside designators will be used instead of left-right designators where appropriate. Inside will be used to describe views from inside the visor, adaptor, headset or headband; & outside to views from outside same.

FIG. 1 is an outside isometric view of one embodiment of a Multiposition Visor Adaptor System (MVAS) according to aspects of the present invention, yoking a visor and attached to a David Clark aviation headset.

FIG. 2 is a side view of the MVAS of FIG. 1, attached to the David Clark aviation headset, with the visor in the down position.

FIG. 3 is an exploded outside isometric view detailing a visor arm portion of the MVAS of FIG. 1, securable to the visor.

FIG. 4a is an exploded isometric outside view of a hinge portion of the MVAS of FIG. 1.

FIG. 4b is an exploded isometric inside view of the hinge portion of FIG. 4a.

FIG. 5a is a side view of the MVAS of FIG. 1, attached to a David Clark headset and with the visor in the mid position.

FIG. 5b is a side view of the MVAS of FIG. 1, attached to a David Clark headset and with the visor in the up position.

FIG. 6 is a partially exploded side view of the MVAS of FIG. 1 and visor.

FIG. 7 is an isometric outside detail view of the adaptor and connector portions of the MVAS of FIG. 1.

FIG. 8a is an inside detail view of the adaptor portion of the MVAS of FIG. 1.

FIG. 8b is an inside view of the adaptor and connector portions of the MVAS of FIG. 1, in fully “in” position.

FIG. 9a is an outside partially exploded view detailing the adaptor and connector portions of the MVAS of FIG. 1, the connector portion presenting index numbers.

FIG. 9b shows an outside view of the detailing the adaptor and connector portions of the MVAS of FIG. 1, the index numbers presented on the connector portion indicating that the adaptor and the connector portions are in a first relative position.

FIG. 10a is a side view of the MVAS of FIG. 1 and the visor and David Clark headset, the adaptor portion disengaged from the connector portion.

FIG. 10b is a side view of the MVAS of FIG. 1 and the visor and David Clark headset, the adaptor portion at the furthest out engaged position relative to the connector portion.

FIG. 10c is a side view of the MVAS of FIG. 1 and the visor and David Clark headset, the adaptor portion at a mid engaged position relative to the connector portion.

FIG. 10d is a side view of the MVAS of FIG. 1 and the visor and David Clark headset, the adaptor portion at the furthest in engaged position relative to the connector portion.

FIG. 11 is a facing view of the David Clark headset detailing the place where the connector portion of the MVAS of FIG. 1 is inserted and secured.

FIG. 12a is an outside isometric view of an alternate aviation headset and a cooperating universal connector portion of a second embodiment MVAS according to aspects of the present invention.

FIG. 12b is an outside isometric detail view of the universal connector portion of the MVAS of FIG. 12a.

List of Elements

| | |
|---|---|
| 10 | Multiposition Visor Adaptor System (MVAS) |
| 12 | Visor |
| 14 | Visor Arm |
| 16 | Visor Securement |
| 18 | Securement Hole |
| 20 | Securement Bolt |
| 22 | Bushing Aperture |
| 24 | Adaptor |
| 26 | Hinge Assembly |
| 28 | Hinge Post |
| 30 | Washer |
| 32 | Bushing |
| 34 | Hinge Tensioner |
| 36 | Headband Connector (D C) |
| 38 | Locking Bolt Slide |
| 40 | Connector Stem |
| 42 | Ratchet Teeth |
| 44 | Stem Slot |
| 46 | Spring Slot |
| 48 | Index Spring |
| 50 | Spring Port |
| 52 | Index Number |
| 54 | Index Window |
| 56 | Aviation Headset* (D C) |
| 58 | Headband Assembly* (D C) |
| 60 | Headpad* |
| 62 | Headband Spring* |
| 64 | Stirrup Clamp* |
| 66 | Stirrup* |
| 68 | Headband Locknut* |
| 70 | Cable Clip* |
| 74 | Clamp Locking Bolt* |
| 76 | Noise Attenuating Dome* |
| 78 | Ear Seal* |
| 80 | Stirrup Mount* |
| 82 | Clamp Guide* |
| 84 | Universal Headband Connector |
| 86 | Microphone Boom* |
| 88 | Volume Control* |
| 90 | Fulcrum Post |
| 92 | Upper Grip |
| 94 | Spring Arm |
| 96 | Lower Grip |
| 98 | Spring Hub |
| 100 | Hub Extension |
| 102 | Grip Arrestor |
| 104 | Aviation Headset* (TH) |
| 106 | Headband Assembly* (TH) |

(D C = David Clark headband style) (TH = Thicker headband style)
(*= Prior Art)

### DETAILED DESCRIPTION

### Static Structure

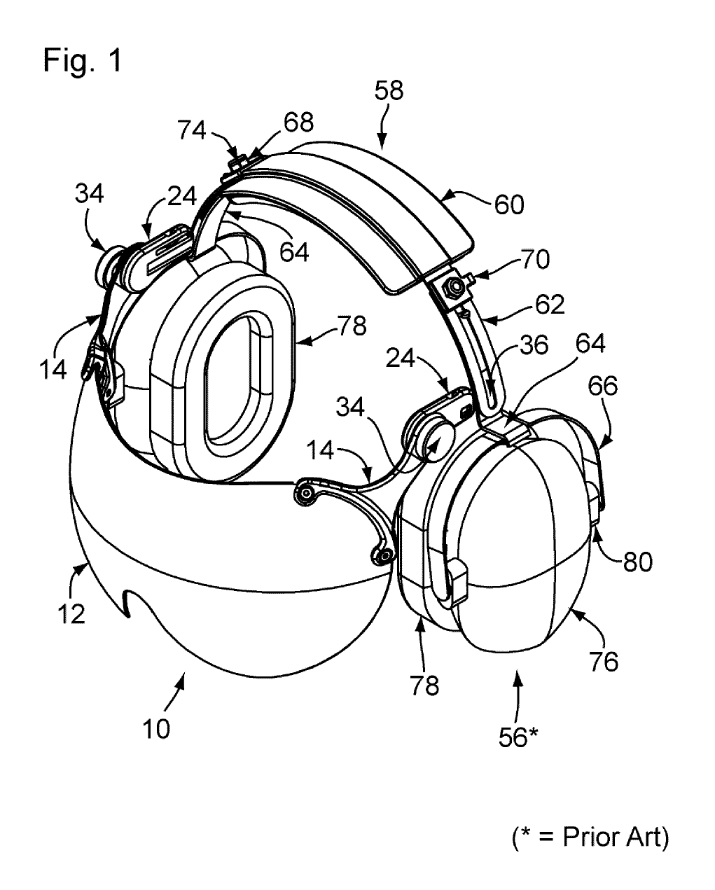

FIG. 1 shows an outside isometric view of the Multiposition Visor Adaptor System (hereafter abbreviated as MVAS) 10 attached to a prior art aviation headset (of the David Clark style; hereafter abbreviated as DC) 56 and a visor 12. Basic elements of the MVAS 10 visible in this view include visor arms 14, hinge tensioners 34, adaptors 24, and a headband connector 36. Basic elements of the prior art aviation headset (DC) 56 visible in this view include a headband assembly 58 (headband) comprising a headpad 60, headband spring 62, stirrup clamps 64, stirrups 66, headband locknuts 68, cable clips 70, clamp locking bolts 74, and associated noise attenuating domes 76, ear seals 78, and stirrup mounts 80.

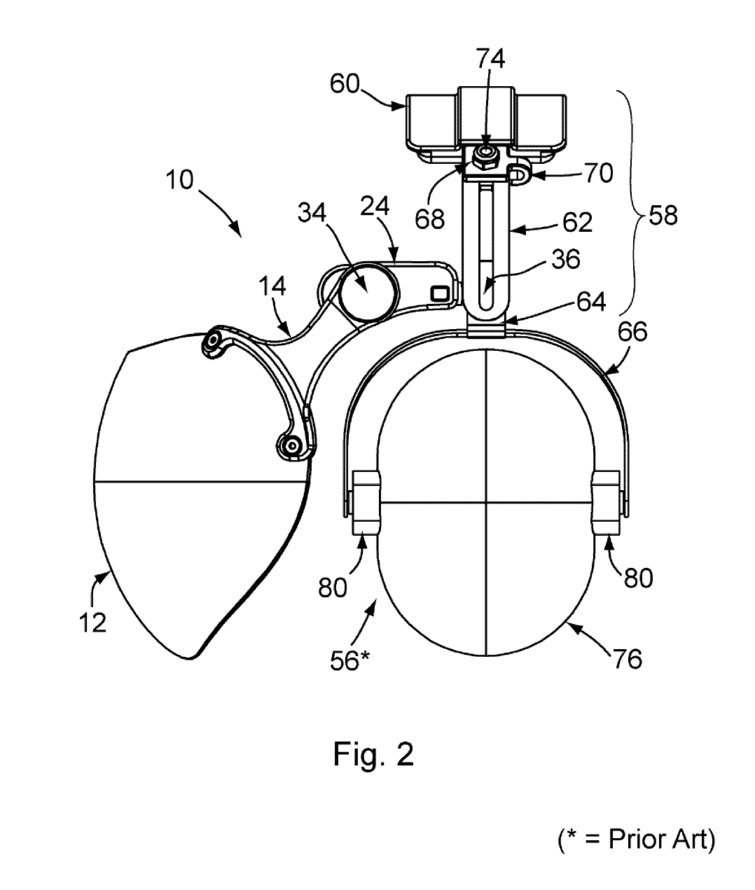

FIG. 2 shows a side view of the MVAS 10, with the visor 12 in the down position, attached to the aviation headset (DC) 56. In this view, elements of the headband assembly 58 for the aviation headset (DC) 56 include the headpad 60, headband spring 62, stirrup clamp 64, stirrup 66, headband locknut 68, cable clip 70, and clamp locking bolt 74. The stirrup 66 is attached to the stirrup mounts 80 on the sides of the noise attenuating dome 76. Basic elements of the MVAS 10 include the visor arm 14, the hinge tensioner 34, the adaptor 24, and a headband connector 36 visible between the headband spring 62 and the stirrup clamp 64.

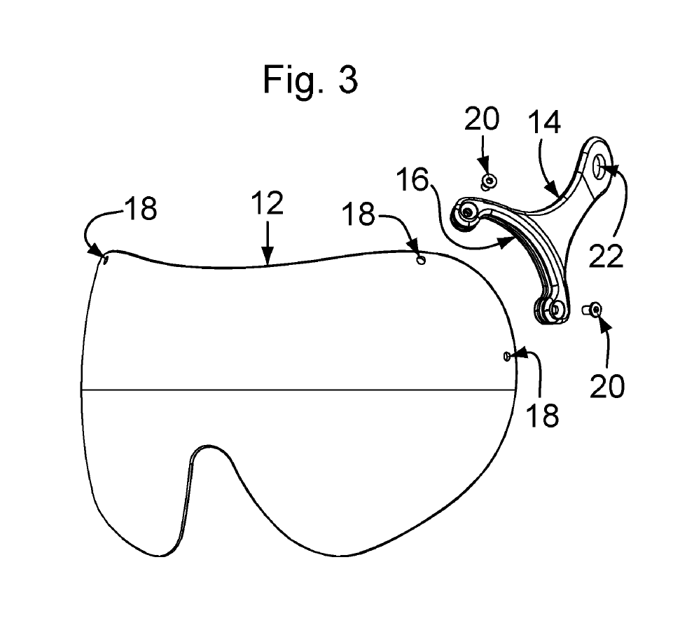

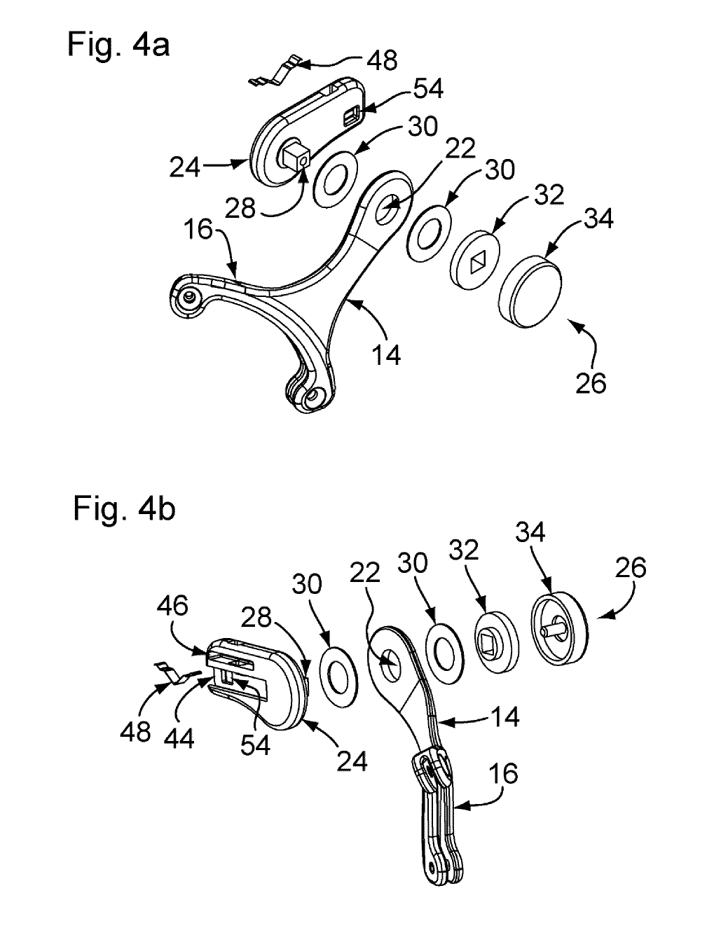

FIG. 3 shows an outside isometric view of the visor arm 14 being securable to the visor 12. The visor securement 16 portion of the visor arm 14 fits over the visor 12 to align with the securement holes 18 so that it may be fastened by the securement bolts 20. For robustness and stability, the securement 16 yokes the visor 12. The visor arm 14 may be attached to the hinge assembly 26 of the adaptor 24 (shown in FIG. 4a below) by means of a bushing aperture 22.

FIG. 4a shows an exploded outside isometric view of the hinge assembly 26 elements connecting the adaptor 24 to the bushing aperture 22 of the visor arm 14. Assembled onto the hinge post 28 of the adaptor 24 are a washer 30, the bushing aperture 22, another washer 30, a bushing 32, and the hinge tensioner 34. Other adaptor 24 elements also shown are an index spring 48, and an index window 54.

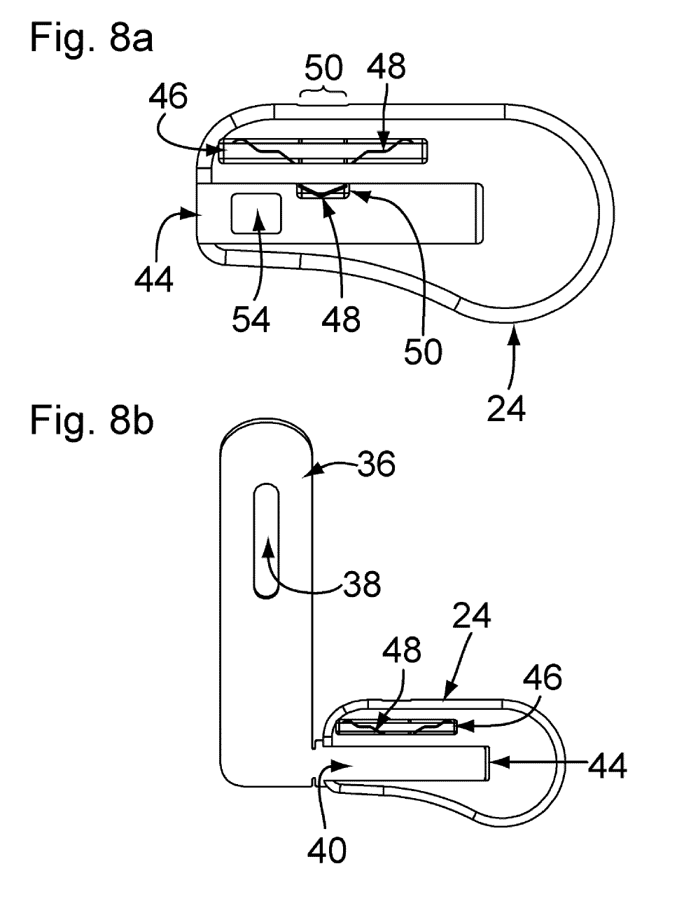

FIG. 4b shows an exploded inside isometric view of the same hinge assembly 26 elements connecting the adaptor 24 to the visor arm 14. Other elements of the adaptor 24 visible from this view include the spring slot 46, where the index spring 48 is inserted, and the stem slot 44, where the connector stem 40 is inserted, as shown in FIGS. 8a & 8b below.

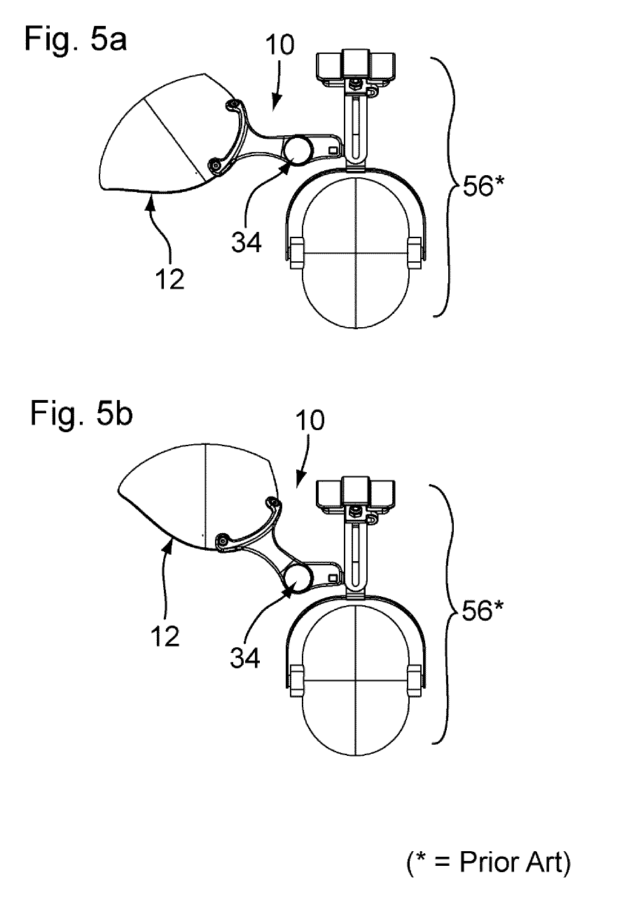

FIG. 5a shows a side view of the MVAS 10 attached to the aviation headset (DC) 56 with the visor 12 in a mid vertical position, whereas FIG. 5b shows a side view of the MVAS 10 attached to the aviation headset (DC) 56 with the visor 12 in an up position, the visor arm 14 being pivotable about and secured by the hinge tensioner 34.

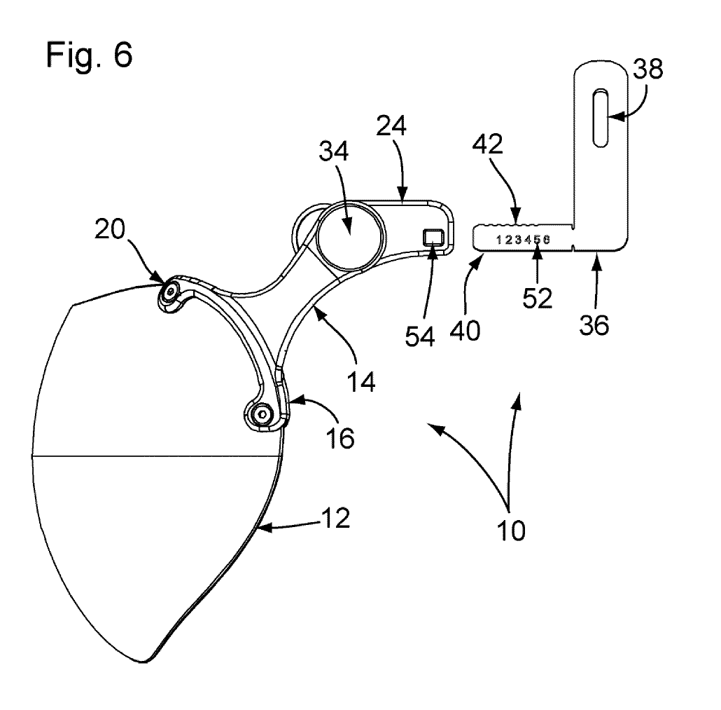

FIG. 6 shows a close-up side view of the basic MVAS 10 elements including the headband connector 36 adapted to fit to the David Clark style aviation headset (DC) 56. (latter not shown) Elements of the headband connector 36 include a locking bolt slide 38, and a connector stem 40 with ratchet teeth 42 and index numbers 52 on its outside surface as shown.

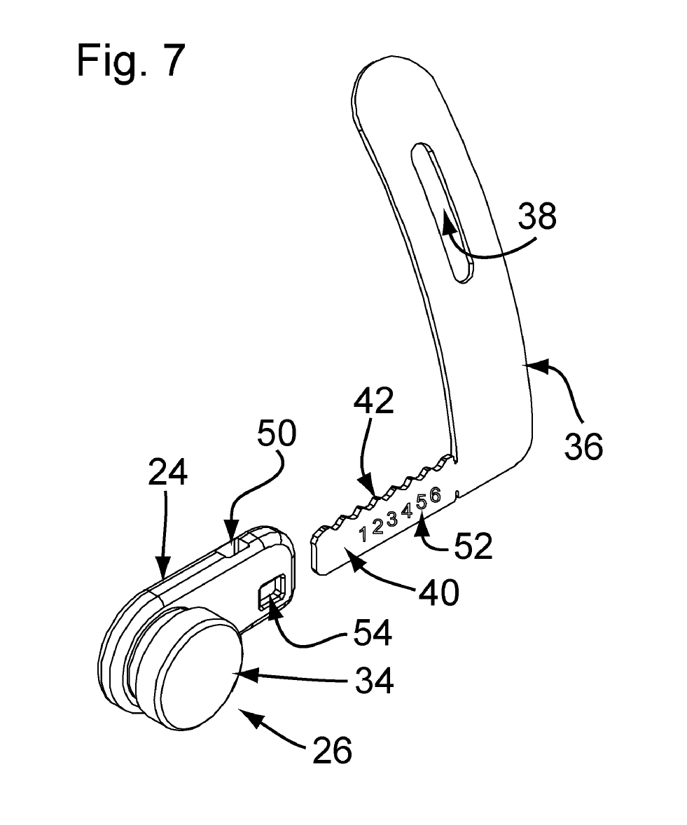

FIG. 7 shows a close-up outside isometric view of the MVAS 10 adaptor 24 without attached visor arm 14, and the headband connector 36 adapted to fit to the David Clark style aviation headset (DC) 56.

FIG. 8a shows a close-up inside view of the MVAS 10 adaptor 24 with the index spring 48 inserted into the spring slot 46, a portion of the index spring 48 protruding into the stem slot 44 adjacent the index window 54. FIG. 8b shows an inside view of the MVAS 10 adaptor 24 with the connector stem 40 of the headband connector (DC) 36 inserted into its stem slot 44.

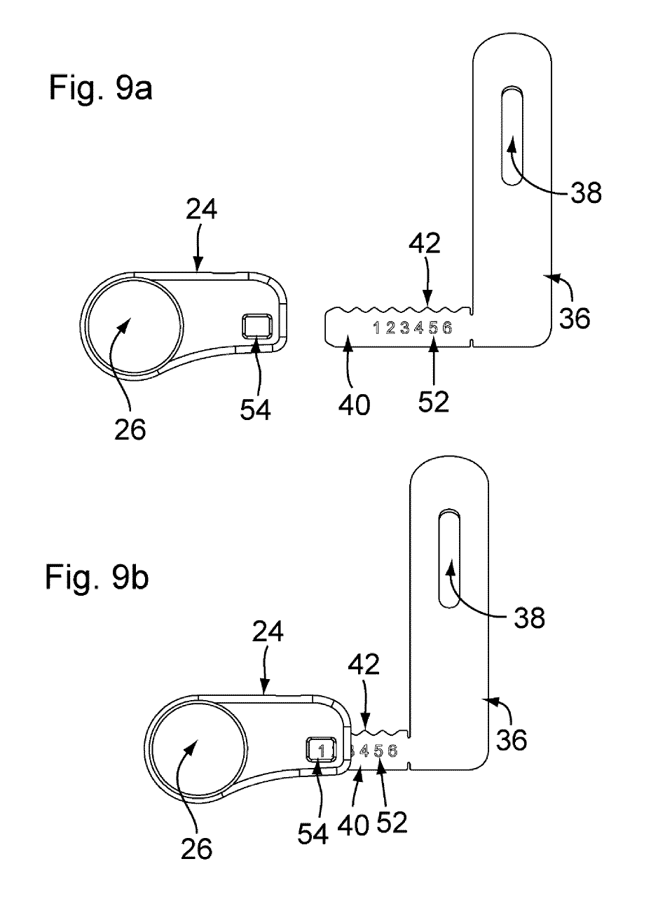

FIG. 9a shows an outside view of the MVAS 10 adaptor 24 with the headband connector (DC) 36 detached and showing its index numbers 52. FIG. 9b shows an outside view of the MVAS 10 adaptor 24 with the connector stem 40 of the headband connector (DC) 36 partly inserted into the adaptor's 24 stem slot 44. Index numbers 52 on the connector stem 40 are visible through the index window 54 of the adaptor 24.

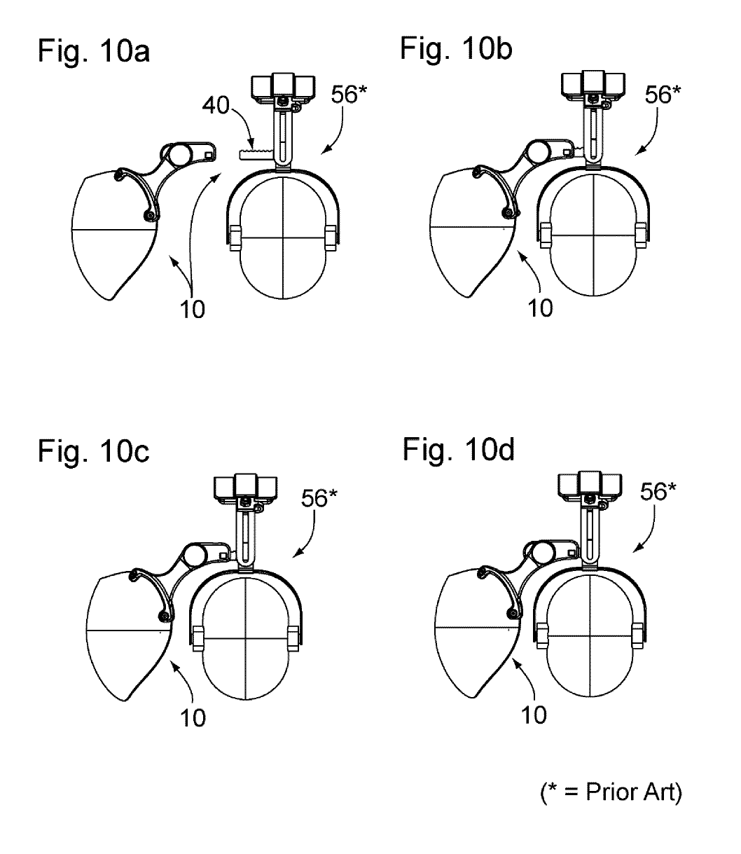

FIG. 10a shows a side view of the MVAS 10 with its adaptor 24 detached from its connector stem 40 which is secured to the aviation headset (DC) 56. FIG. 10b shows a side view of the MVAS 10 with its adaptor 24 at the “out” position of the connector stem 40. FIG. 10c shows a side view of the MVAS 10 with its adaptor 24 at the “mid” position of the connector stem 40. FIG. 10d shows a side view of the MVAS 10 with its adaptor 24 at the fully “in” position of the connector stem 40. These positions are merely illustrative and do not preclude more discriminating degrees of horizontal extension.

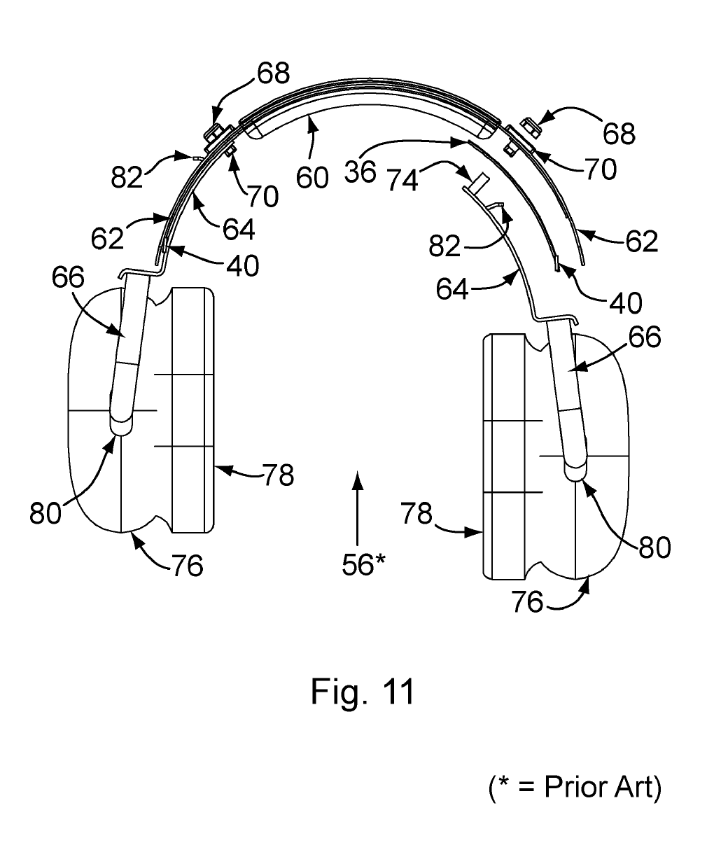

FIG. 11 shows a facing view of the aviation headset (DC) 56 to better illustrate where the MVAS 10 headband connector 36 with its stem 40 is inserted (right side) and secured (left side). Elements of this headset 56 not clearly visible elsewhere include the clamp locking bolt 74, and the clamp guide 82.

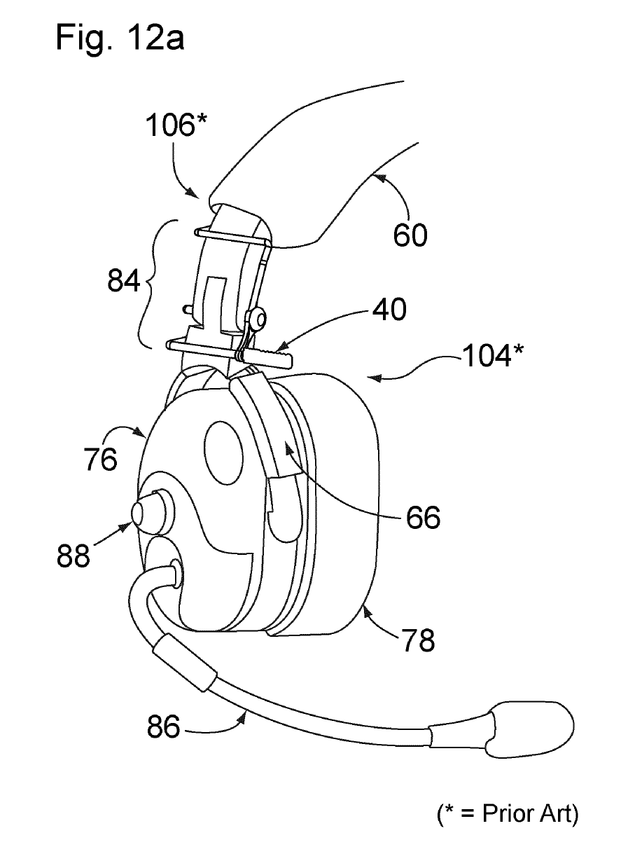

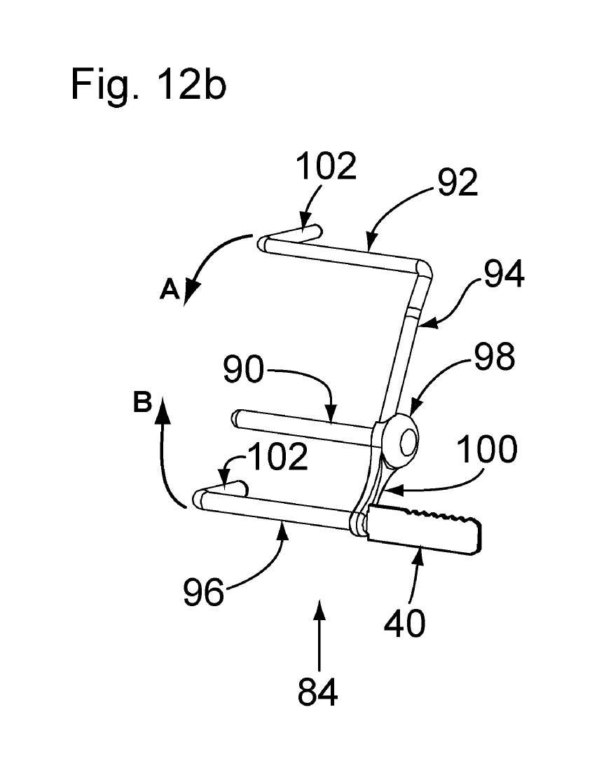

FIG. 12a shows an outside isometric view of an alternate prior art aviation headset 104 with a thicker headband (=TH) assembly 106 and a universal headband connector 84 where its connector stem 40 inserts into the stem slot 44 of a common adaptor 24 (not shown). Additional elements shown on this aviation headset (TH) include a microphone boom 86 and volume control 88. Note that these latter elements have been omitted from the figures showing the David Clark aviation headset only for clarity, but are included in a significant number of commonly used David Clark headsets.

FIG. 12b shows a close-up outside isometric view of the universal headband connector 84 as employed on each side of the headband assembly (TH) 106 of the alternate aviation headset (TH) 104. Elements of each universal headband connector 84 include a fulcrum post 90, upper grip 92, spring arm 94, lower grip 96, spring hub 98, hub extension 100, grip arrestors 102 as shown, and the connector stem 40.

### Dynamic Structure

How each element or assembly functions and interacts with each other element or assembly will now be described. For clarity of presentation, related elements will be described together as the following assemblies: visor assembly, hinge assembly, and adaptor assembly. Connecting the headband assembly 58 to the prior art aviation headset 56 will also be discussed.

The visor assembly is comprised of one visor arm 14 (or two opposing visor arms 14), as shown in FIGS. 1 and 3, having a visor securement 16 that yokes the visor 12. The bushing aperture 22 at the end of the visor arm 14 fits into and rotates within the hinge assembly 26 of each adaptor 24 permitting the visor assembly to pivot up and down as needed.

The hinge assembly 26 is comprised of the elements shown in FIGS. 4a & 4b that fit between the hinge post 28 and the hinge tensioner 34. The hinge assembly 26 permits the visor assembly to smoothly rotate around the axis of each hinge post 28, by means of the washers 30 and bushing 32. The hinge tensioners 34 can be loosened to permit the visor assembly to be adjusted into an infinite number of vertical positions. The user can then lock the visor assembly in place by tightening each threaded hinge tensioner 34 so that the hinge assembly 26 secures the bushing aperture 22 end of each visor arm 14 in a fixed position, as demonstrated in FIGS. 5a & 5b. Or the hinge tensioner 34 can be tightened just enough so that the visor assembly can be repositioned, but it will remain in its desired position. By this means the friction of the hinge assembly holds the visor assembly in place, but still permits it to be easily repositioned with only one hand.

In this regard, it can be seen that the hinge assembly 26 includes a hinge post 28 and a hinge bushing 32 that cooperate with the hinge tensioner 34 to resist a change in tension when the hinge assembly 26 pivots, by isolating the hinge tensioner 34 from pivot forces of the hinge assembly 26. The hinge assembly 26 further includes a pair of washers 30 between the hinge post 28 and the hinge bushing 32 to entrap the arm 14, to further isolate the hinge tensioner 34 from pivot forces. The hinge bushing 32 circumscribes the hinge post 28 and the hinge post 28 has a perimeter shaped to resist rotation of the hinge bushing 32 and the hinge tensioner 34 abuts the hinge bushing 32 and threads into the hinge post 28 through the hinge bushing 32 to urge the hinge bushing 32 toward the hinge post 28.

As shown in FIGS. 6 & 7, the adaptor assembly is comprised of the adaptor 24, including the hinge assembly 26, and those elements that permit horizontal adjustment of the visor assembly, i.e. controlled adjustment in and out from the pilot's face, such as its stem slot 44, spring slot 46, index spring 48, and spring port 50. The adaptor assembly also includes the headband connector 36, if using the common David Clark headset, or the universal headband connector 84, if using the thicker headband style headset 104 (see FIG. 12a). Horizontal adjustment of the visor assembly is achieved by means of the connector stem 40 at the end of each headband connector (36 or 84), which is inserted into the stem slot 44 of each adaptor 24. The top of each connector stem 40 has ratchet teeth 42 (see FIG. 7) which are engaged by the index spring 48 through the spring port 50. As the connector stem 40 slides into the stem slot 44 (see FIG. 8b) the tension of the index spring 48 secures the stem 40 in its index position and thereby the visor assembly in each fixed horizontal position, as shown in FIGS. 10a through 10d.

All headband connectors terminate in a connector stem 40, which inserts into the MVAS 10 adaptor 24, but each connector can be securely attached to each aviation headset's respective headband designs. Each David Clark headband connector 36 (DC) is designed to fit between the headband spring 62 and each stirrup clamp 64, and are secured by the headband locknut 68 to the clamp locking bolt 74, as it passes through the locking bolt slide 38 (see FIG. 7), and is aligned by the clamp guide 82 as shown in FIG. 11. While the locking bolt slide 83 employs a continuous slot to permit headset adjustment, a multiplicity of independent holes performing an equivalent function can serve the same purpose, and may increase securement. Alternate connector securement methods will be described below.

### Operation

Operation of the Multiposition Aviation Visor Adaptor System (MVAS) 10 will now be described in greater detail. As discussed above, the MVAS 10 is comprised of the visor, hinge, adaptor, and connector assemblies. One embodiment employs a headband connector 36 (DC) that is secured to each side of the headband spring 62 of a David Clark style aviation headset (DC). The adaptor assembly slides onto the connector stem 40 so that at least the first (#1) index number 52 is fully visible in the index window 54, in order to ensure that the connector stem 40 and stem slot 44 can support the weight of the adaptor and visor assemblies, and so that the index spring 48 has engaged the first ratchet teeth 42.

Assuming full use of all elements shown in FIG. 1, and now that the connector stem 40 has securely engaged the adaptor 24, the MVAS 10 can be adjusted horizontally towards the pilot's face by sliding the adaptor 24 inwards onto the connector stem 40 (or outwards if too close). When the optimal horizontal position for maximum glare reduction and comfort has been achieved, the pilot may then untighten (rotate counterclockwise) each hinge tensioner 34 so that the visor assembly may be adjusted to a vertical position that suits the current illumination conditions and aircraft orientation, and then locked into place by retightening (rotate clockwise) the same tensioners 34. Hinge tensioners 34 may be tightened just enough to permit easy and continuous readjustment of the visor assembly, which will remain securely in place without further tightening being needed. Vertical repositioning of the MVAS 10 visor assembly is illustrated in FIGS. 2, 5a and 5b, while horizontal repositioning in FIGS. 10a-10d.

Vertical repositioning of the visor assembly is achieved by loosening or tightening the hinge tensioner 34, a circular knob employing a threaded bolt which engages an equivalently threaded receiving end anchored in the hinge post 28. By this means the hinge tensioner 34 tightens or loosens the hinge assembly 26 around the bushing aperture 22 of the visor arm 14, as needed to adjust and lock the position of the visor assembly. (see FIGS. 4a and 4b) Note that the head of the threaded bolt is embedded in the material of the hinge tensioner 34 (knob), and are therefore treated as one unit in this embodiment. Similarly, the threaded anchor is embedded in the hinge post 28, but other solutions may be employed to equivalent ends. The square orifice of the bushing 32 fits over the square end of the hinge post 28, thereby locking the two elements together and thereby providing an external bearing surface around which the bushing aperture 22 can rotate when the tensioner 34 is released.

Horizontal repositioning of the visor assembly is achieved by sliding the connector stem 40 in or out of the stem slot 44 of the adaptor 24.

Additional securement and positional indexing is achieved by the use of an index spring 48 which presses through the spring port 50, in between the ratchet teeth 42 of the top edge of the connector stem 40, as shown in FIG. 8a, and inferred in FIG. 8b by means of FIGS. 7 and 9a. When the connector stem 40 has slid far enough into the stem slot 44, the first index number 52 is visible through the index window 54, as shown in FIG. 9b. By this means, horizontal repositioning is controlled and indexed by reference to the index numbers 52 visible through the index windows 54 on the outside of each MVAS 10 adaptor 24, and this ensures that both sides of the visor assembly are positioned an equal, as well as optimal distance from the wearer's head.

Thus the adaptor 24 includes an index spring 48 configured for operative engagement with the plurality of ratchet teeth 42 on the stem 40 so as to urge the stem 40 to occupy only discrete predetermined positions within the slot 44. Additionally, the stem 40 includes a plurality of index indicia 52, each of the plurality of index indicia 52 corresponding to a respective one of the plurality of ratchet teeth 42 and the adaptor 24 includes an index window 54 configured to display a respective one of the plurality of index indicia 52 as a function of a relative position of the stem 40 within the slot 44.

Still further adjustability is provided by the connector 36, which can be attached to the headband 58 at a user-selected location between the headpad 58 and the stirrup 66.

In this regard, the MVAS 10 can be understood to be a system for connecting a visor 12 to a headset 56 headband 58, comprising: a connector 36 attachable to the headband 58; an adaptor 24 adjacent the connector 36 and having a first end and a second end; an arm 14 adjacent the adaptor 24 and having a first end and a second end, the second end of the arm 14 having a securement 16 for securing the visor 12; a first translational link 38 for linking the connector 36 and the headband 58 and permitting relative adjustment there between; a second translational link 40, 44 for linking the connector 36 and the first end of the adaptor 24 and permitting relative adjustment there between; and a rotational link 26, 22 for linking the second end of the adaptor 24 and the first end of the arm 14 and permitting relative adjustment there between.

In that way, at least one of: the connector 36 cooperates with the headband 58 to provide the first translational link; the connector 36 and the adaptor 24 cooperate to provide the second translational link; and the adaptor 24 and the arm 14 cooperate to provide the rotational link. At least one link may be able to unlink, for example adaptor 24 unlinking from the connector 36, for example the slot 44 unlinking from the stem 40.

Generalizing from the foregoing, at least one link may be indexed 42, 48, 52 and have an index window 54 for indicating relative adjustment.

### ALTERNATIVES AND VARIATIONS

Alternate embodiments of the system will now be described, some in detail, and include a universal headband connector, and a ratcheting tensioner.

The headband design employed on the most commonly used aviation headset at present is that made by the David Clark Company. A significant share of David Clark competitors employ a thicker headband design, as illustrated in FIG. 12a, so that in order to employ the MVAS 10 on these headsets, an alternate headband connector design is needed. In FIG. 12a, the universal headband connector 84 is shown attached to the alternate headband assembly 106 (TH=thicker headband) of the alternate style aviation headset 104 (TH).

The universal headband connector 84 uses an internal spring to compress two grip arms against the headband assembly 106 (TH) and a post. The universal headband connector 84 terminates with the same connector stem 40 as the first embodiment, and employs the same elements. FIG. 12b shows a detailed view of the elements of the universal headband connector 84, where the direction of the forces required to compress the internal spring (not shown) is illustrated by thick A & B arrows. By this means, in order to secure the universal headband connector 84 to the headband assembly 106 (TH), the upper grip 92 of the spring arm 94 (arrow A) is compressed towards the lower grip 96 (arrow B) by means of the hub extension 100, around the axis of the spring hub 98 and fulcrum post 90.

While compressed, the appropriately sided universal headband connector 84 is then fitted onto the headband assembly 106 (TH) as shown in FIG. 12a, and then released. The upper grip 92 and lower grip 96 terminate in grip arrestors 102 as shown, which prevent the connector 84 from sliding forwards once attached. The surfaces of the upper 92 and lower grips 96, and the fulcrum post 90 may be sheathed in or impregnated with a frictional substance such as rubber or elastomer in order to more readily secure the connector 84 to the headband 106, and prevent their unwanted movement due to the excessive vibration common in an aircraft cockpit.

The universal adaptor can have a variety of embodiments which allow it to adapt to various headsets in a practical and unobtrusive manner, while permitting an equivalent overall functionality as in the preferred embodiment.

The hinge tensioner 34 may additionally employ a means to transmit audible and or tactile indication of its degree of rotation allowing the pilot to feel or hear index clicks when turning the tensioner 34 to ensure that the hinge assembly 26 is not overtightened. By this means the pilot can be aware that only a certain number of clicks are all they need to secure the visor assembly in place, and that more turns might damage the hinge assembly. One method to achieve this index mechanism would be a spring and pawl that would fit between the bushing 32 and the tensioner 34, and would require a means to trip the pawl as the tensioner 34 is adjusted around the outer circumference of the bushing 32. Index marks on the tensioner 34 and the visor arm 14 could also be used to prevent over-tensioning. Other methods may be used if they achieve the same results.

A secondary hinge mechanism where the visor arm attaches to the visor is also contemplated, so that when the visor is stowed in an upright position, the visor pivots flat to the pilot's head, instead of projecting outwards.

Suitable materials for constructing the Multiposition Visor Adaptor System will now be described. The visor may be made of polycarbonate, tempered glass, optical glass or similar transparent durable material capable of retaining optical sunshield coatings. The visor arm, most elements of the hinge assembly and the adaptor, excluding those mentioned below, can be made of rigid plastics, thermoplastics, carbon fiber, aluminum, etc. Washers may be brass, Teflon®, or other low friction durable surface. The bushing may be made of rigid plastic or Teflon® or carbon fiber, nylon; but if employing an index mechanism, will need to be made of a material strong enough to endure the wear of a pawl ratchet. The index spring and spring inside the universal headband connector would be made of high tension spring steel. The headband connector (DC) could be carbon fiber, high strength steel, or any material that has both the strength to support the weight of the remaining MVAS elements, and the ability to flex with the existing headband design. The arms, grips and post of the universal headband connector (TH) may use solid or hollow metal, or any other material strong enough to maintain structural integrity with repeated flexing, while consistently securing the connector to the headband. Grip coverings or coatings employed with the universal connector could be rubber or elastomer for enhanced in place securement to the headband.

Other advantages of using the MVAS over other methods or devices will now be described. The MVAS allows the pilot to protect his vision and hearing in a variety of environments. The MVAS is adaptable to a variety of currently used aviation headsets, while the basic design may comprise headset connectors for additional designs not shown herein. An aircraft pilot now has the option of visor sunscreen protection when needed, in the orientation that is most effective, and without sacrificing communication, hearing protection or comfort. The MVAS allows the pilot to fine tune the position of the visor to suit his equipment, environment, and changing circumstances. At any time, if the visor is not needed, it may be stowed in the fully up position and locked, so that it is out of the way, yet accessible if needed. Or the visor assembly may be easily removed when not required, and quickly and easily reattached when needed.

The MVAS can have applications outside of its use with aviation communication or hearing protectors, such as in sport shooting, automobile racing, emergency response (helmets) and similar activities where hearing, communication, and adjustable vision protection are needed.

Thus, it will be seen that there have been taught a number of illustrative embodiments of a system 10 for connecting a visor 12 to a headset 58, 104 headband 58, 106, the headband 58, 106 having a headband spring 62 that supports a headpad 60 and a stirrup 66, comprising: a connector 36, 84 attachable to the headband spring 62 at a user-selected location between the headpad 60 and the stirrup 66, wherein the connector 36, 84 has a stem 40; an adaptor 24 adjacent the connector 36, 84 and having a first end and a second end, wherein: the first end of the adaptor 24 has a slot 44 complementary with the stem 40 for receiving and retaining the stem 40, wherein the adaptor 24 is operable to translate with respect to the connector 36, 84 under user-urging, and the second end of the adaptor 24 has a hinge assembly 26; and an arm 14 adjacent the adaptor 24 and having a first end and a second end, wherein: the first end of the arm 14 has an aperture 22 complementary with the hinge assembly 26 for reception into the hinge assembly 26, wherein the arm 14 is operable to pivot about the second end of the adaptor 24, and the second end of the arm 14 has a securement 16 for securing the visor 12.

For broad application, the system 10 can incorporate a variety of connectors 36, 84, for connection to a variety of headsets 56, 104. For example, the system 10 might be connected to a David Clark headset 56 by a David Clark headband connector 36 having a locking bolt slide 38.

Alternatively, the system 10 might be connected to a generic headset 104, for example a headset 104 with a thicker headband 106, by a universal connector 84 having a fulcrum post 90, upper grip 92, spring arm 94, lower grip 96, spring hub 98, hub extension 100, and grip arrestors 102 as shown in FIG. 12b.

The foregoing description of the specific embodiments and method of installation should be considered as illustrative only, and not limiting. Other forming techniques and other materials may be employed towards similar ends. Various changes and modifications will occur to those skilled in the art, without departing from the true scope of the invention as defined in the claims.

I claim:

1. A system for connecting a visor to a headset headband, the headband having a headband spring that supports a headpad and a stirrup, comprising:
a) a connector attachable to the headband spring at a user-selected location between the headpad and the stirrup, wherein the connector has a stem;
b) an adaptor adjacent the connector and having a first end and a second end, wherein:
i) the first end of the adaptor has a slot complementary with the stem for receiving and retaining the stem, wherein the adaptor is operable to translate with respect to the connector under user-urging, and
ii) the second end of the adaptor has a hinge assembly; and
c) an arm adjacent the adaptor and having a first end and a second end, wherein:
i) the first end of the arm has an aperture complementary with the hinge assembly for reception into the hinge assembly, wherein the arm is operable to pivot about the second end of the adaptor, and
ii) the second end of the arm has a securement for securing the visor.

2. A system as claimed in claim 1, wherein the connector includes an elongated bolt slide for slidable attachment to the headband.

3. A system as claimed in claim 1, wherein the connector is a universal headband connector.

4. A system as claimed in claim 1, wherein the stem has a plurality of ratchet teeth.

5. A system as claimed in claim 4, wherein the adaptor further includes an index spring configured for operative engagement with the plurality of ratchet teeth on the stem so as to urge the stem to occupy only discrete predetermined positions within the slot.

6. A system as claimed in claim 5, wherein:
a) the stem includes a plurality of index indicia, each of the plurality of index indicia corresponding to a respective one of the plurality of ratchet teeth; and
b) the adaptor includes an index window configured to display a respective one of the plurality of index indicia as a function of a relative position of the stem within the slot.

7. A system as claimed in claim 1, wherein the hinge assembly includes a hinge tensioner.

8. A system as claimed in claim 7, wherein the hinge assembly further includes a hinge post and a hinge bushing that cooperate with the hinge tensioner to resist a change in tension when the hinge assembly pivots, by isolating the hinge tensioner from pivot forces of the hinge assembly.

9. A system as claimed in claim 8, wherein the hinge assembly further includes a pair of washers between the hinge post and the hinge bushing to entrap the arm, to further isolate the hinge tensioner from pivot forces.

10. A system as claimed in claim 9, wherein:
a) the hinge bushing circumscribes the hinge post and the hinge post has a perimeter shaped to resist rotation of the hinge bushing; and
b) the hinge tensioner abuts the hinge bushing and threads into the hinge post through the hinge bushing to urge the hinge bushing toward the hinge post.

11. A system as claimed in claim 1, wherein the securement is shaped to yoke the visor.

12. A system for connecting a visor to a headset headband, comprising:
a) a connector attachable to the headband;
b) an adaptor adjacent the connector and having a first end and a second end;
c) an arm adjacent the adaptor and having a first end and a second end, the second end of the arm having a securement for securing the visor;
d) a first translational link for linking the connector and the headband and permitting relative adjustment there between;
e) a second translational link for linking the connector and the first end of the adaptor and permitting relative adjustment there between; and
f) a rotational link for linking the second end of the adaptor and the first end of the arm and permitting relative adjustment there between.

13. A system as claimed in claim 12, wherein, at least one of:
a) the connector cooperates with the headband to provide the first translational link;
b) the connector and the adaptor cooperate to provide the second translational link; and
c) the adaptor and the arm cooperate to provide the rotational link.

14. A system as claimed in claim 13, wherein at least one link is operable to unlink.

15. A system as claimed in claim 14, wherein the first end of the adaptor is operable to unlink from the connector.

16. A system as claimed in claim 13, wherein at least one link is indexed.

17. A system claimed in claim 16, wherein the at least one link includes an index window for indicating relative adjustment.

18. A system as claimed in claim 13, wherein:
a) the connector includes a stem; and
b) the first end of the adaptor includes a slot,
wherein the stem and slot cooperate to provide the second translational link.

19. A system as claimed in claim 13, wherein:
a) the second end of the adaptor includes a hinge assembly; and
b) the first end of the arm includes an aperture,
wherein the hinge assembly and the aperture cooperate to provide the rotational link.

20. A system as claimed in claim 13, wherein the securement is operable to yoke the visor.
